(19) United States
(12) Patent Application Publication
(10) Pub. No.: US 2012/0305532 A1
(43) Pub. Date: Dec. 6, 2012

(54) System and Method for High-Speed Robotic Cladding of Metals

(76) Inventor: Tennyson Harris, Brampton (CA)

(21) Appl. No.: 13/485,693

(22) Filed: May 31, 2012

Related U.S. Application Data
(60) Provisional application No. 61/491,775, filed on May 31, 2011.

(51) Int. Cl. B23K 9/04

(52) U.S. Cl. 219/76.14

(57) ABSTRACT

A metal cladding process using an automated welding tool, the tool comprising at least one torch for receiving two weld wires to produce a molten pool on the metal, the process having the steps of providing a set of instructions in a non-transitory computer readable medium, the instructions executable by a processor to control the travel speed of the at least one torch; and control the oscillation pattern and frequency of the at least one torch, the oscillation pattern comprising a pause at each of a center position, a lateral left position and a lateral right position relative to a weld reference line.

### CROSS-REFERENCE TO RELATED APPLICATIONS

This application claims the benefit of priority to U.S. Provisional Application Ser. No. 61/491,775, filed on May 31, 2011.

### FIELD OF THE INVENTION

The present invention relates to metal cladding, and more particularly to a system and method for high-speed robotic cladding of metal.

### BACKGROUND OF THE INVENTION

Cladding or coating refers to a process where a metal, corrosion resistant alloy or composite (the cladding material) is bonded electrically, mechanically or through some other high pressure and temperature process onto another dissimilar metal (the substrate) to enhance its durability, strength or appearance. The majority of clad products made today use carbon steel as the substrate and aluminum, nickel, nickel alloys, copper, copper alloys and stainless steel as the clad materials to be bonded. Typically, the purpose of the clad is to protect the underlying steel substrate from the environment it resides in. Cladded steel plate, sheet, pipe, and other tubular products are often used in highly corrosive or stressful environments where other coating methods cannot prevail.

Cladding of low alloy steels is a complex process which generally requires total control of the welding process and total situation awareness. During the cladding process, power is fed through cables attached to a rotary table, and cladding is performed with a wire, shielding gas or flux by building up multiple beads. Typically, an operator must monitor the welding head voltage, amperage, and bead profile during the cladding process.

The current cost of clad steel limits its use in a variety of applications and industries, as the cost of clad steel for high corrosion application is about five times the cost of carbon steel. The primary buyers of cladded steel products today are the petroleum (oil, gas, and petrochemical), chemical, marine exploration, mining, shipping, desalination and nuclear industries.

In the prior art, there are a number of processes for performing metal cladding, including Metal Inert Gas (MIG) welding, Tungsten Inert Gas (TIG) welding, strip welding, electro slag, and plasma spray. Selecting the best depends on many parameters such as size, metallurgy of the substrate, adaptability of the coating material to the technique intended, level of adhesion required, and availability and cost of the equipment. Typically the final use environment often determines the clad materials to be combined, the thickness and number of layers applied. The cladding may be applied to the inside, outside or both sides of a substrate depending upon which surface(s) needs to be protected.

Generally speaking, these cladding processes tend to be slow, and costly due to consumables, labour and other costs. For example, with MIG welding, strip welding, and electro slag, the operator is compelled to stop the machine and clean it between each pass. Unless such is performed after each weld pass, there is increased risk lack of fusion, and defects. As an illustrative example, a prior art process for cladding a Cr—Mo steel tube sheet is performed at a welding speed between 5 inches/minute and 9 inches/minute in a semi-automatic process with the welding head attached to a 2-axis positioner. This prior art process is slow and an expensive way to produce cladding, as it limits the work to one position and causes high levels of unnecessary labour, and high levels of UV rays are given off while the machine is working.

The plasma spray process uses a 5 kW transverse flowing CO₂ laser, which is used for cladding a Co base alloy. Powder is pre-placed on the substrates which add to the cost, and the cladding results show a cladding microstructure with close texture and small size grain. However, plasma spray emits high levels of infrared and ultraviolet radiation, including noise during operation, necessitating special protection devices for operators. In addition, plasma spray may have an increased chance of electrical hazards, require significant operator training, and have higher equipment costs and inert gas consumption. Furthermore, with all welding processes, there may be dangerous fumes given off during the welding process.

Another technique is laser cladding, which uses a laser heat source to deposit a thin layer of a desired metal on a moving substrate. The deposited material can be transferred to the substrate by several methods: powder injection, pre-placed powder on the substrate, or by wire feeding. The process has some significant drawbacks, such as high investment costs, low efficiency of the laser sources, and lack of control over the cladding process, poor reproducibility attributable to the small changes in the operating parameters such as laser power, beam velocity and powder feed rate.

The common denominator of these clad production methods is that they are slow and expensive. Buyers need to weigh the advantages of cladded steel over other corrosion materials and faster production processes (from other inorganic metal finishing processes like fusion bond (FBE) epoxies, galvanizing and chromate and zinc priming) in their purchasing decisions.

It is thus an object of the present invention to mitigate or obviate at least one of the above-mentioned disadvantages.

### SUMMARY OF THE INVENTION

In one of its aspects, there is provided a method of cladding a metal using a programmable robotic welding torch having a leader wire and a trailer wire, the method comprising the steps of:
providing a non-transitory machine readable medium comprising instructions stored thereon and executable by a processor to cause the processor to:
   oscillate the torch about a reference weld line on a surface of the metal having at a predefined speed to form a weld bead by:
      positioning the leader at point p₀ located a predetermined distance from the reference weld line;
      positioning the trailer at point p₁ on the reference line;
      causing the leader to begin welding from point p₀ along a weld path s₁ towards the reference line, such that the weld path s₁ meets the reference line at an angle θ; and simultaneously causing the trailer to begin welding from point p₁ along weld path s_{1′} away from the reference line, such that the weld path s_{1′} meets the reference line at an angle φ;
      causing the leader and the trailer to proceed along the weld paths s₁ and s_{1′}, respectively, until the leader pauses at point p₄ on the reference line and the trailer pauses at point p₂ located a predetermined distance from the reference line;
      causing the leader to begin welding from point p₄ along weld path s₂ along the reference line; and simultaneously causing the trailer to begin welding from point p₂ along a weld path s_{2′} parallel to the reference line;
      causing the leader and the trailer to proceed along the weld paths s₂ and s_{2′}, respectively, until the leader pauses at point p₅ on the reference line and the trailer pauses at point p₃ located a predetermined distance from the reference line;
      causing the leader to begin welding from point p₅ along weld path s₃ away from the reference line at an angle φ with the reference line; and simultaneously causing the trailer to begin welding from point p₃ along a weld path s_{3′} towards the reference line such that the weld path s_{3′} is at an angle φ with the weld path s_{2′};
      causing the leader and the trailer to proceed along the weld paths s₃ and s_{3′}, respectively, until the leader pauses at point p₈ located a predetermined distance from the reference line and the trailer meets the reference line at an angle θ and pauses at point p₄;
      causing the leader to begin welding from point p₈ along weld path s₄ parallel to the reference line; and simultaneously causing the trailer to begin welding from point p₄ along a weld path s_{4′};
      causing the leader and the trailer to proceed along the weld paths s₄ and s_{4′}, respectively, until the leader pauses at point p₉ located a predetermined distance from the reference line and the trailer pauses at point p₅ located on the reference line;
      causing the leader to begin welding from point p₉ along weld path s₅ towards the reference line, such that the weld path s₅ is at an angle φ with the weld path s₄; and simultaneously causing the trailer to begin welding along weld path s_{5′} away from the reference line, such that the weld path s_{5′} is at an angle φ with the reference line;
      causing the leader and the trailer to proceed along the weld paths s₅ and s₅′, respectively, until the leader pauses at point p₁₀ on the reference line and the trailer pauses at point p₆ located a predetermined distance from the reference line;
      causing the leader to begin welding from point p₁₀ along weld path s₆ along the reference line; and simultaneously causing the trailer to begin welding from point p₆ along weld path s_{6′} parallel to the reference line;
      causing the leader and the trailer to proceed along the weld paths s₆ and s_{6′}, respectively, until the leader pauses at point p₁₁ located on the reference line, and the trailer pauses at point p₇ located a predetermined distance from the reference line;
      causing the leader to begin welding from point p₁₁ along weld path s₇ away from the reference line and at angle φ with the reference line; and simultaneously causing the trailer to begin welding from point p₇ along weld path s_{7′} towards the reference line, such that the weld path s₇ is at an angle φ with the weld path s_{6′};
      causing the leader and the trailer to proceed along the weld paths s₇ and s_{7′}, respectively, until the leader pauses at point p₁₂ located a predetermined distance from the reference line, and the trailer meets the reference line at an angle θ and pauses at point p₁₀;
      causing the leader to begin welding from point p₁₂ along weld path s₈ parallel to the reference line; and simultaneously causing the trailer to begin welding following a weld path s_{8′} along the reference line; and
      causing the leader and the trailer to proceed along the weld paths s₈ and s_{8′}, respectively, until the leader pauses at point p₁₃ located a predetermined distance from the reference line, and the trailer pauses at point p₁₁ located on the reference line.

In another of its aspects, there is provided a method of controlling a robot tool to perform a weaving action for producing a weld on a metal with a torch having at least two wires, the method comprising the steps of:
programming an oscillation pattern for the robot tool defined by a set of parameters, the oscillation pattern including a pause at each of a center position, a lateral left position and a lateral right position relative to the weld;
programming the torch travel speed of at least 9 inches per second;
programming a corresponding wire feed speed for each of the at least two wires; and
delivering sufficient power to the welding torch such that each of the at least two wires produce a common molten pool dictated by programmed oscillation pattern, and at the programmed torch travel speed.

In another of its aspects, there is provided a metal cladding process using an automated welding tool, the tool comprising at least one torch for receiving two weld wires to produce a molten pool on the metal, the process having the steps of:
providing a set of instructions in a non-transitory computer readable medium, the instructions executable by a processor to:
   control the travel speed of the at least one torch;
   control the feed speed of the two weld wires to the torch;
   control the stickout of the two weld wires;
   control the angle of the weld wires relative to the metal;
   control the oscillation pattern and frequency of the at least one torch, the oscillation pattern comprising a pause at each of a center position, a lateral left position and a lateral right position relative to a reference weld line;
   control the power to the at least one torch; and
whereby the oscillation pattern produces a weld bead having low dilution with minimal solidification shrinkage and cracking.

Advantageously, coating results in deposition of a thin layer of material (e.g., metals and ceramics) onto the surface of a selected material. This changes the surface properties of the substrate to those of the deposited material. The substrate becomes a composite material exhibiting properties generally not achievable through the use of the substrate material alone. The coating provides a durable, corrosion-resistant layer, and the core material provides the load bearing capability. A number of different types of metals, such as chromium, titanium, nickel, copper, and cadmium, can be used in the metallic coating process.

Advantageously, as flux is not needed in the welding process, it is possible to weld continually to complete a metal cladding job without stoppage. When using flux core electrode wire, a gaseous cloud is produced and some of the flux ends up in the molten weld pool and gathers up impurities from the slag which covers the weld as it cools. Accordingly, constant cleaning and vigilance is required to maintain the weld area free of slag and other contaminants, which when left uncleaned would affect the weld strength or the integrity of the weld. Therefore, unlike prior art welding systems and methods, the present invention consumes less quantities of energy, materials and pollution, thereby substantially minimizes the impact on the environment. In addition, the steps of cleaning flux and slag is obviated thus resulting in significantly reduced labour. In addition, the cladding process in one aspect of the invention is fully automated, such that human operators do not have to be positioned near high UV ray discharges and toxic fumes given off by the welding arc, thus making the process safer than prior art systems.

In another of its aspects, there is provided a non-transitory machine readable medium comprising instructions executable by a processor to cause the processor to: control the travel speed of the welding tool, the wire feed speed, and the weaving pattern to minimize lack of fusion problems that may result at the toe of a weld bead when the travel speed of the welding tool is increased.

In another aspect, the work piece may be cladded in a stable non-rotatiing state, which eliminates with the grounding problems caused by turning the work piece during cladding. Accordingly, a workpiece may be continuously clad without excessive stopping and higher speeds than in prior art systems. Advantageously, the high speeds keep the inter-pass temperatures and heat input to a minimum. The resulting grain structure in the metal is better than MIG, TIG, strip, and less electro slag is produced due to the low heat input. More particularly, the metal cladding process disclosed herein employs a welding tool travelling and welding at significantly increased speeds, and in which the consumable wire feed speed is increased correspondingly to produce a molten pool.

### BRIEF DESCRIPTION OF THE DRAWINGS

Several preferred embodiments of the present invention will now be described, by way of example only, with reference to the appended drawings in which:

FIG. 1a depicts a schematic diagram of an apparatus for performing a gas metal arc welding (GMAW) pulse-time synchronized twin-arc tandem process, in one embodiment;

FIG. 1b shows exemplary steps for an arc welding (GMAW) pulse-time synchronized twin-arc tandem process;

FIG. 2a depicts a novel welding tool oscillation pattern in accordance with an embodiment;

FIG. 2b depicts the results of using the welding tool oscillation pattern of FIG. 2a;

FIG. 3a depicts a schematic diagram of a high-speed robotic welding tool used to form cladding beads on a base metal in accordance with an embodiment;

FIGS. 3b and 3c show the results of using the high-speed robotic welding tool of FIG. 3a;

FIG. 4a depicts an exemplary work cell; and

FIG. 4b depicts an exemplary work cell in another embodiment.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention may also be described herein in terms of screen shots and flowcharts, optional selections and various processing steps. Such functional blocks may be realized by any number of hardware and/or software components configured to perform to specified functions. For example, the present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any, programming or scripting language such as C, C++, Java, assembler, PERL, extensible markup language (XML), smart card technologies with the various algorithms being implemented with any combination of data structures, objects, processes, routines or other programming elements. Further, it should be noted that the present invention may employ any number of conventional techniques for data transmission, signaling, data processing, network control, and the like.

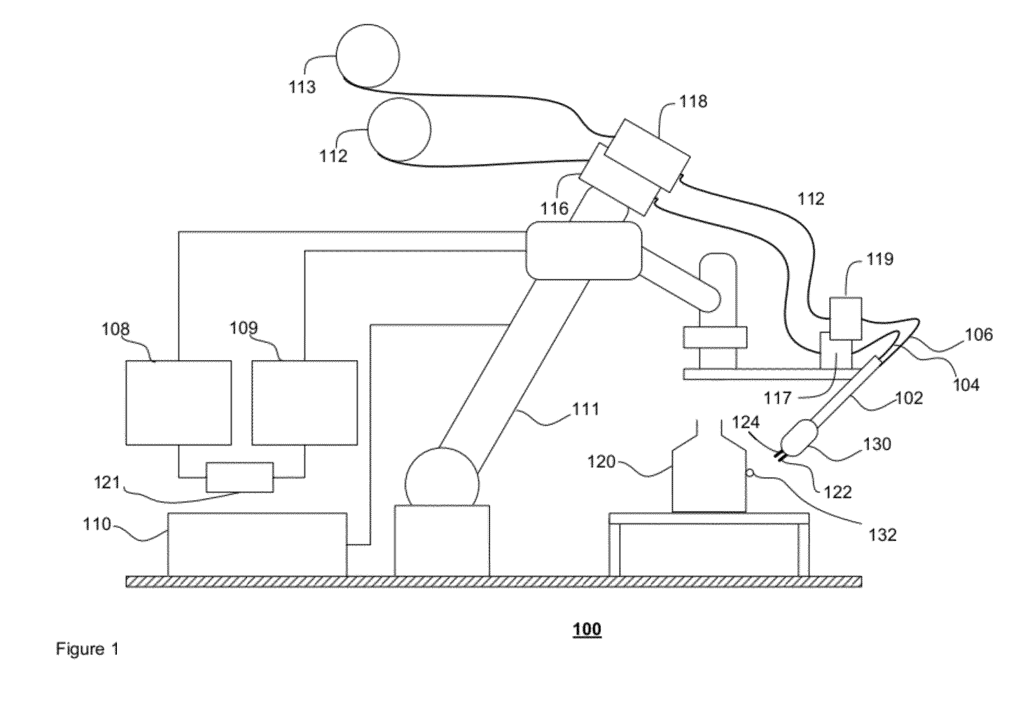

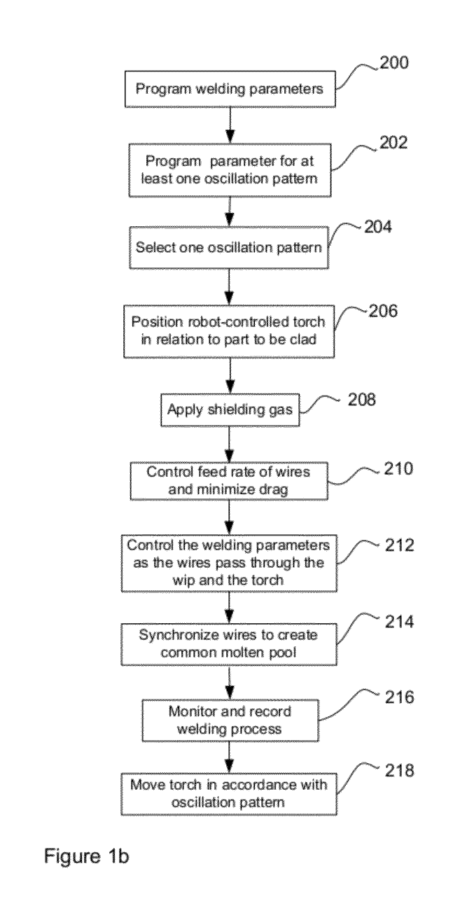

For the purposes of the present disclosure, the high-speed process for cladding metals using a robotic system will hereinafter be generally referred to as High Speed Robotic Cladding (“HSRC”). HSRC incorporates an automatic Gas Metal Arc Welding (GMAW) pulse-time synchronized twin-arc tandem process, which may be performed by an exemplary system 100 as illustrated in FIG. 1a.

Looking at FIG. 1a, the exemplary welding system 100 comprises a welding apparatus 101 having a tandem torch 102 with two solid electrode wires 104, 106, and powered by power supplies 108, 109, respectively. An exemplary 6-axis robot 110 with external 3-axis may be used to control the torch 102 via a robot controller 111, and therefore provides total situation control over the welding process. The six axis robot 111 includes the robot body motions (x, y, z axis combined with three-axis wrist motion (pitch, roll and yaw)). The body motions and the wrist motions allow the welding torch 102 to be manipulated in space in almost the same fashion as a human being would manipulate the torch 102. The electrode wires 104, 106 are continuously fed from spools 112, 113 at a speed controlled by a wire feed system 115 comprising wire feeders 116, 117, and 118, 119, respectively. The welding wires 104, 106 are positioned in proximity with each other above part to be clad 120. Each electrode wire 104 or 106 produces an arc which melts the electrode wire 104, 106 and the part 120, such that the molten electrode wires 104, 106 transfer across the arc, to form a molten pool and subsequently a cladding. The part 120 may be a SA 516-70 plate with a 12 inch diameter and 3 inches thick. The wires 104, 106, such as fully automated high speed robotic cladding trials using Inconel 82 (182) or Inconel 52 (152) can be controlled independently of each other and their operation can be synchronized by a synchronization system 121, which is described in more detail below. Inconel 82 (182) or Inconel 52 (152) wire provides a nickel-chromium alloy corrosion resistant surface, and also resistive to oxidizing acid. Therefore, the tandem welding process comprises two completely independent welding circuits, each with its own welding wire 104, 106, power source 108, 109, torch cable, wire feeders 116, 117 and 118, 119, and contact tips 122, 124. A shielding gas is used to shield the cladding area from atmospheric gases, and thus protect the molten metal from oxidation and contamination. The shielding gas may be an inert gas such as argon, which is returned into the atmosphere in the exact same condition, therefore argon is a renewable gas and poses less of an environmental impact than other gases, such as nitrogen which can combine with oxygen to form nitrogen dioxide (NO₂) or oxygen which can form metal oxides.

As will be explained in more detail below, system 100 uses the tandem welding torch 102 to produce a molten pool while cladding at high-speed, while producing desired welding beads with predetermined characteristics, and with minimal defects. The solid electrode wires 104, 106 are electrically isolated from each other, and are positioned in line, one behind the other, in the direction of welding. Accordingly, one electrode wire 104 is designated the lead wire or leader, while the other electrode wire 106 is designated the trail wire or trailer. The two contact tips 122, 124 are contained within a common torch body 130, surrounded by a common gas nozzle to provide the shielding gas. The two contact tips 122, 124 are angled in such a way that during welding, the two wires 104, 106 produce dual arcs which both contribute to a single molten puddle 132. As will be described below, the lead wire 104 controls one side of the bead while the trail wire 106 controls the other side of the bead, to produce a consistent bead.

The synchronization system 121 synchronizes the pulse frequency of the power delivered by the two power supplies 108 and 109, and ultimately to the electrode wires 104, 106. Pulse synchronization stabilizes the arcs by reducing interference between the two welding circuits and optimizes the penetration and geometry of the cladding. In addition, the synchronized pulse current minimizes spatter and potential arc blow problems.

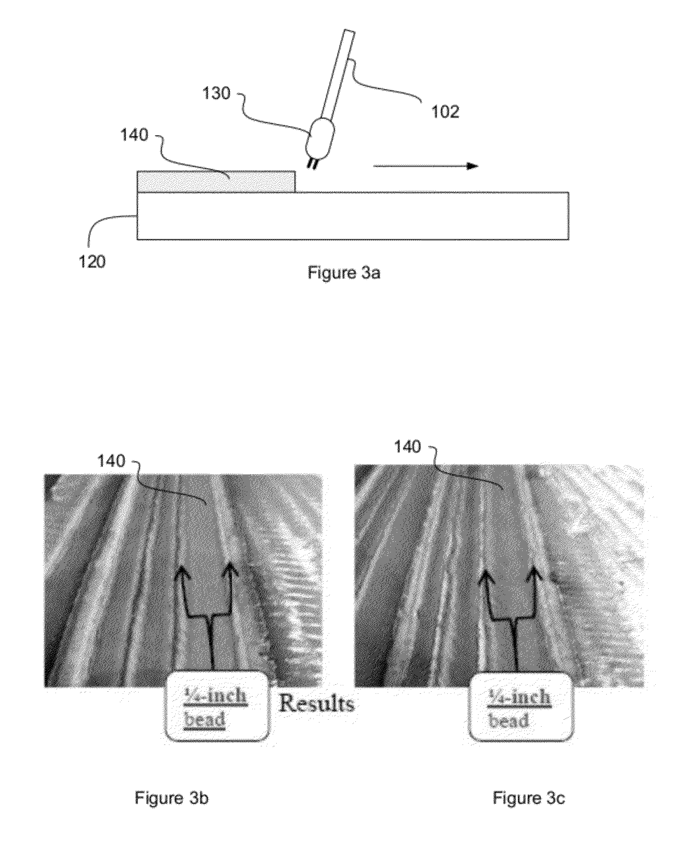

The tandem wires 104, 106 may be setup on spools to provide a continuous supply of wire. For example, for electrode wire 104, a first wire feeder 116 is used to pull the wire 104 out of the wire spool 112 or drum through the robot wip. A second wire feeder 117 is used to minimize resistance or drag on the wire 104 and maintain a predetermined feed rate, and without damaging the wire 104. In one embodiment, the second wire feeder 117 is located adjacent to the torch 102. Correspondingly, the electrode wire 106 is drawn from wire spool 113 by the first wire feeder 118, and a second wire feeder 119 located adjacent to the torch 102 is used to minimize resistance or drag on the wire 106 and maintain a predetermined feed rate. When the feed rate is properly controlled at an optimal feed rate, the resulting bead includes substantially straight edges, as shown in FIGS. 3b and 3c. However, when there is resistance then the feed rate is non-optimal and the wire 104 is stretched due to its inherent elasticity to produce a non-uniform bead with jagged edges, which is not ideal. Such inconsistent bead characteristics then necessitate deposition of additional layers in order to achieve the desired bead characteristics, thus resulting in increased consumption of resources, such as electrode wire, time and labour. s.

The robotic system 110 may be a Fanuc R-J3 robot 110 available from Fanuc, Japan. The robot controller 111 runs the programming and relays instructions to and from the robot 110, and to the welding apparatus 101. The controller 111 may an Allen Bradley PLC, available from Allen Bradley, U.S.A. Welding parameters are set at the power sources 108, 109 via digital communication from either a programmable logic controller (PLC) associated with a work cell or by a robot controller 111. The programs may be modified to maintain the welding process within suitable operating parameters. The welding operator programs the robot controller 111 with the instructions required for a given welding procedure. The robot 110 carries out the commands set by the program to perform the operations of the welding process, such as the weaving patterns. In one exemplary embodiment, the robotic system 100 does not require a positioner to move the part 120 when commanded by the program, as is common in prior art systems. Instead, the torch 102 moves about a stationary part or work piece 120, as will be described later.

TABLE A
Base material: Mild Steel
Process: GMAW
Process specific: Automatic Time Twin

| | |
|---|---|
| Deposition rate (kg/h): | |
| Welding speed (cm/min): | 66-95 |
| Ground material: | Mild Steel |
| Filler metal: | Inconel 82 |
| Diameter (mm): | 1.6 mm |
| Shielding gas: | 100% Ar |
| Flow rate (cfh): | 60 cfh |
| Power source: | TPS 5000 x2 |
| Software-vers./Eprom/DB no.: | 03-0234 |
| Welding program: | 1272 |
| Welding torch: | Robacta Drive - RA900 |
| Length (m): | 2.6 m |
| Torch neck angle (°): | 0 |
| Remote control: | RCU5000i |
| Weld preparation angle (°): | 0 |
| Weld. pos.: | 1F□ 2F□ 3F□ 4F□ 1G□ |
| | 2G□ 3G□ 4G□ 6G□ |
| Welding angle (°): | Neutral |
| Travel angle (°): | 0 |
| Weld seam: | Combinations seam Weld cladding |
| Weld seam QC: | X-ray □ Ultrasonic □ |
| | Hardness test □ |
| | Compressing test □ Tensile test □ |
| | C & E [symbol] Visual [symbol] |
| Mode: | Pulse |
| Electrode polarity: | DC+ |
| Preheat temp. (° C.): | 121 min 177 max (first layer only) |
| Weld. roller drive: | 4 |
| Groove profile: | HD 1.6 Ø |
| Control unit: | |
| Automating component: | Motoman robot/ |
| Root protection: | Forming gas 100% Ar □ |
| | Forming gas 95% N2 5% H2 □ |
| | Forming gas 90% N2 10% H2 □ |

Table A below shows exemplary parameters that may be programmed for use in a GMAW pulse-time synchronized twin-arc tandem process, using the system 100. For example, instructions for a welding program may be input via a user interface associated with the power supplies 108, 109. The user interface allows the input of a plurality of parameters pertaining to the welding process, power sources 108, 109 and welding torch 102, among others. For example, in one exemplary embodiment, the welding system 100 comprises two TransPuls Synergic 5000 welding machines, from Fronius, Austria, with digitized, microprocessor-controlled inverter power sources 108, 109. Generally, the parameters are input via one of the many interface modes depending on the welding application, or remotely via an interface communicatively coupled to the power source 106 or 108, such as a remote control unit RCU5000i, from Fronius. The plurality of parameters forms the welding program which is assigned an identifier and is stored in memory, such as an EPROM. For an alloy steel base metal to be clad using a pulse-mode GMAW twin-arc tandem process with a torch 102, such as a Fronius Robacta Drive—RA900, the following parameters may be selected: the deposition rate of the Iconel 52 wire is set at 24 to 30 lbs/hr, at a welding speed of 66 to 95 cm/minute, and the shielding gas, such as argon, is supplied at a rate of 60 cfh. Other parameters include: sheet thickness; welding current; wirefeed speed; wire diameter; torch neck angle, weld preparation angle, weld position, welding angle, travel angle, weld seam (combination seam/weld cladding), weld seam quality control (X-ray, Ultrasonic, Hardness tests), compressing test (tensile test, C & E, visual) feeder inching speed, welding process, electrode polarity, preheat temperature, weld roller drive, groove profile, control unit, automating component (robot, semi automatic) and root protection.

TABLE B

| | Layer No. | | | |
|---|---|---|---|---|
| | 1 | 1 | 2-4 | 2-3 |
| Torch Orientation | L-T | L-T | L-T | L-T |
| Cladding Profile | Flat | Radius | Flat | Radius |
| Wire feed speed (m/min) | 150 | 150 | 215 | 150 |
| Actual current (A) | 161 | 161 | 227 | 161 |
| Welding voltage (V) | 19.7 | 19.7 | 20.5 | 19.7 |
| Feeder Creep | SFI | SFI | SFI | SFI |
| Feeder Inch | 400 | 400 | 400 | 400 |
| Start current (A, %) | — | — | — | — |
| Start current time (s) | off | off | off | off |
| End current (A, %) | 55 | 55 | 55 | 55 |
| End current time (s) | 1.5 | 1.5 | 1.5 | 1.5 |
| Slope up time (s) | 0.1 | 0.1 | 0.1 | 0.1 |
| Slope down time (s) | 1.5 | 1.5 | 1.5 | 1.5 |
| Welding speed (cm/min) | 66 | 66 | 95 | 66 |
| Stickout (mm) | 20 | 20 | 20 | 20 |
| Oscillation width (mm) | 2.8 | 2.8 | 1.8 | 2.8 |
| Weave Angle (deg) | 0 | 0-45 | 0 | 0-45 |
| Oscillation frequency (Hz) | 4.0 | 4.0 | 4.0 | 4.0 |

Table B shows exemplary predefined sets of parameters that may be programmed for a particular weaving pattern or oscillation pattern for the torch 102, using the GMAW pulse-time synchronized twin-arc tandem process with system 100 of FIG. 1. The operational sequence of the torch 102 is therefore dictated by the oscillation pattern based on the programmed instructions from a robot controller, a PLC program or user defined PLC code. As is well known in the art, weaving patterns provide for improved joint properties when compared to a straight path. The shape of the weaving pattern, including the width and location of dwell periods, can be adjusted to improve joint properties such as tensile strength, fatigue strength, shear strength, and hardness. The weaving pattern is dependent on the wire feed speed (m/min), the welding speed (cm/min), the oscillation width (mm), the weave angle (deg) and the oscillation frequency (Hz), among others. More particularly, the electrode wire 104, 106 extension, or stickout may be in the range of 17 to 20 mm to ensure proper welding arc lengths. The arc length is the distance of the arc formed between the end of the electrode wire 112 or 114 and the part 120. Significantly longer arc lengths produces spatter, increased puddle heat, low deposition rates flatter welds with reduced build up, and wider welds, and deeper penetration. Shorter arc lengths may result in less puddle heat, narrower welds with high build-ups and less penetration. Thus, the arc length may be used to control the puddle size, and to control the depth of penetration causing high dilution. Therefore, in order to maintaining a constant arc length, the electrode wires 104, 106 are fed to the tandem torches 102, 104 at a predetermined speed by the wire feeding system, and in accordance to the welding program. In this example the stickout is set at 20 mm.

Looking at FIG. 1b, in one exemplary cladding process using the system 100, the process comprises one or more of the following steps of: programming welding parameters for a twin-arc tandem welding process of a part 120 (step 200); programming parameters for at least one weaving pattern associated with the motion of the torch 102 by the robot 110 via a robot controller 111 or a programmable logic controller (PLC) (step 202); selecting one of the programmed weaving patterns (step 204); positioning the torch 102 in relation to the stationary part 120 (step 206); applying a shielding gas in the vicinity of the cladding area on the part 120 before the wires 104, 106 are withdrawn from the wire spools 112, 113 by the wire feeders wire feeders 116, 118 mounted on the multi-axis or robotic system and the wire feeders wire feeders 117, 119, adjacent the torch 102 (step 208); controlling the feed rate of the wires 104, 106 to the torch and minimizing the drag between the two pairs of wire feeders 116, 118 and 117, 119 (step 210); controlling the welding parameters as the wire 104, 106 pass through the wip (i.e. the liner or cord between the wire feeders 112, 114 and the welding torch 102) and the tandem welding torch 102 (step 212); synchronizing the tandem wires 104, 106 to create a common molten pool by pulsing current and voltage melting the wires 104, 106 onto the part 120 to form a welding bead (step 214); monitoring and recording the welding process using multiple cameras including a seam tracking camera, a weld puddle camera, and one or more 3D cameras (step 216); and moving the tandem torch 102 in accordance with a programmed oscillation pattern at speeds between 66 cm/min and 95 cm/min to cover an area of the part 120 being clad (step 218).

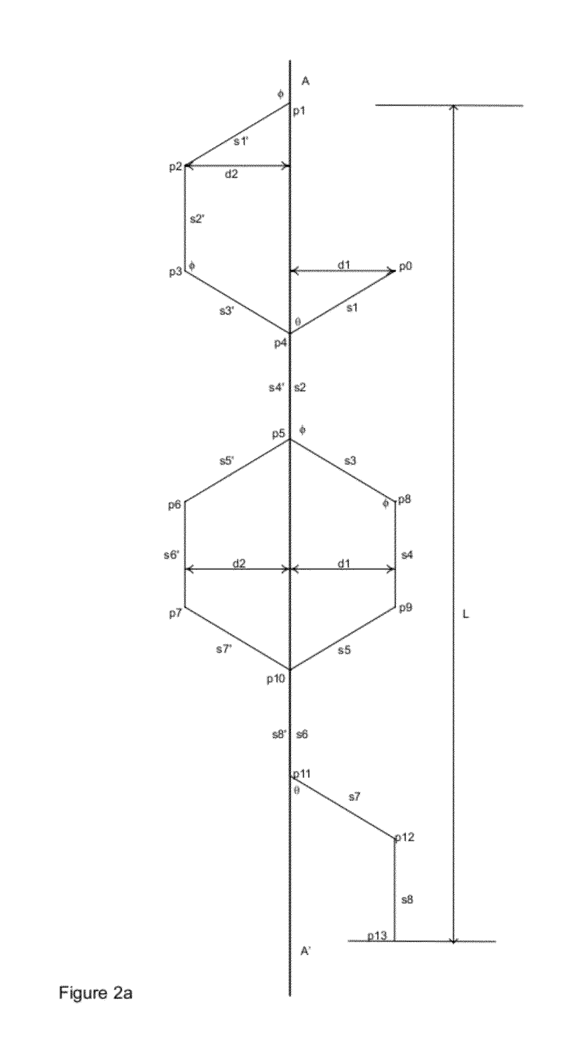

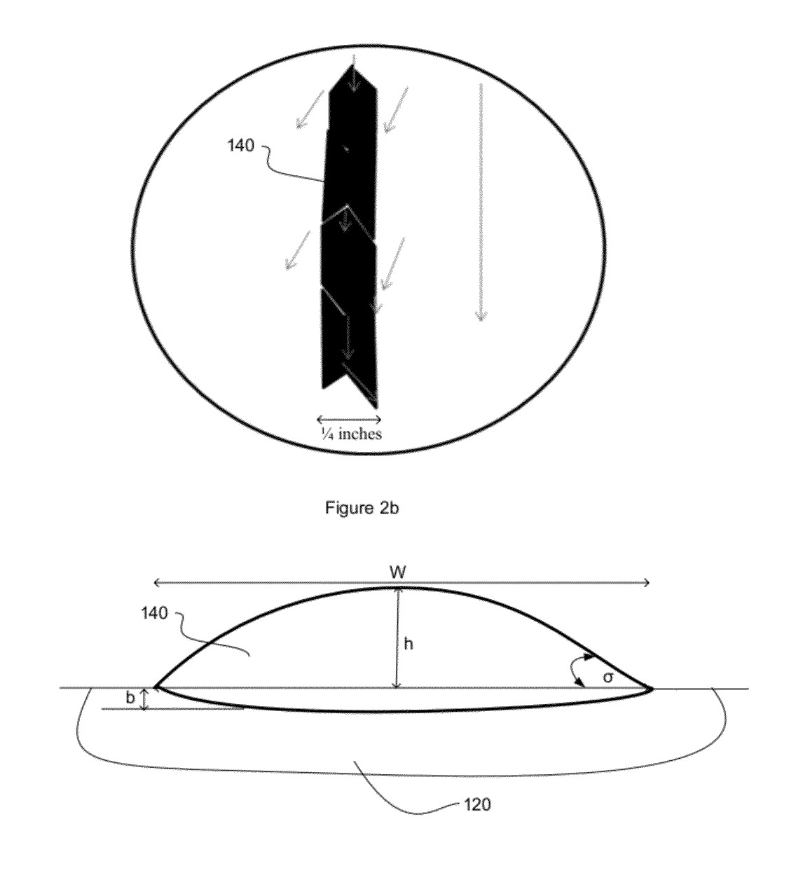

Generally, when the welding torch 102 travels at speeds of over 5 inches per minute, one of the most common defects is a lack of fusion at the toe of a cladded bead. However, these defects are significantly reduced using the exemplary parameters shown in Table B for a weaving pattern of FIG. 2a. The weaving pattern of FIG. 2a determines the nature of the resultant weld bead, in terms of: penetration, build up, porosity, undercut and overlap. As such, the combination of the oscillation pattern of FIG. 2a and a welding torch 102 travel speed of approximately 5 to 9 inches per minute compensates for the lack of fusion inherent most prior art systems.

As described above, the system 100 may be associated with a multi axis robotic system to clad a part 120 using an exemplary oscillation pattern of FIG. 2a. The oscillation pattern undertaken by the torch 102, and hence the lead wire 104 and trail wire 106, is controlled by programmed instructions stored in computer readable medium and executable by a processor to cause the torch 102 and in particular the lead wire 104 and trail wire 106 to perform the exemplary steps described below.

With a reference weld line A-A′ on the base metal having been chosen, and the torch 102 oscillates right and left of that reference line while moving along the reference weld line A-A′ at a predefined speed to form a weld bead 140, as shown in FIG. 2b. For example, the lead wire 104 is positioned at point p₀ located a predetermined distance d₁ from the reference weld line A-A′, and the trail wire 106 is positioned at point p₁ on the reference line A-A′. Starting from the initial resting point p₀, the leader 104 begins welding following a weld path s₁ towards the reference line A-A′, such that the weld path s₁ meets the reference line A-A′ at an angle θ. At the same time, starting from the initial resting point p₁, the trailer 106 begins welding following a weld path s_{1′} away from the reference line A-A′, such that the weld path s_{1′} meets the reference line A-A′ at an angle φ. The tandem wires 104, 106 proceed along their given paths s₁ and s_{1′}, respectively, until the leader 104 pauses at point p₄ on the reference line A-A′ and the trailer pauses at point p₂ located a predetermined distance d₂ from the reference line A-A′. Given that the tandem wires 104, 106 are separated by a fixed distance within the torch 102, the tandem wires 104, 106 thus move in tandem and therefore the distance d₁ is equal to distance d₂. Accordingly the length of the path s1 is equal to the length of the path s1′, and the angle φ of the trailer 106 equals (180−θ) degrees.

Following the pause at point p₄, the leader 104 begins welding along weld path s₂ along the reference line A-A′, such that the weld segment s₂ is parallel to the reference line A-A′. At the same time, following the pause at point p₂ the trailer 106 begins welding following a weld path s_{2′} parallel to the reference line A-A′. Therefore, s_{2′} forms an edge of the weld to the left of the reference line A-A′, such that a weld pool is formed between the reference line A-A′ and the weld segment s_{2′}. The tandem wires 104, 106 proceed along their given paths s₂ and s_{2′}, respectively, until the leader 104 pauses at point p₅ on the reference line A-A′ and the trailer pauses at point p₃ located a predetermined distance d₂ from the reference line A-A′. Accordingly, the length of the path s₂ is equal to the length of the path s_{2′}.

Following the pause at point p₅, the leader 104 begins welding along weld path s₃, away from the reference line A-A′ and at angle φ with the reference line A-A′. At the same time, following the pause at point p₃ the trailer 106 begins welding following a weld path s_{3′} towards the reference line A-A′, such that the weld path s_{3′} is at an angle φ with the weld path s_{2′}. The tandem wires 104, 106 proceed along their given paths s₃ and s_{3′}, respectively, until the leader 104 pauses at point p₈ located a predetermined distance d1 from the reference line A-A, and the trailer meets the reference line A-A′ at an angle θ and pauses at point p₄. Accordingly, the length of the path s₃ is equal to the length of the path s_{3′}.

Following the pause at point p₈, the leader 104 begins welding along weld path s₄ parallel to the reference line A-A′. At the same time, following the pause at point p₄ the trailer 106 begins welding following a weld path s_{4′} along the reference line A-A′. Therefore, s₄ forms an edge of the weld to the right of the reference line A-A′, such that a weld pool is formed between the reference A-A′ and the weld segment s₄. The tandem wires 104, 106 proceed along their given paths s₄ and s_{4′}, respectively, until the leader 104 pauses at point p₉ located a predetermined distance d₁ from the reference line A-A′, the trailer, 106 pauses at point p₅ located on the reference line A-A′. Accordingly, the length of the path s₄ is equal to the length of the path s_{4′}.

Following the pause at point p₉, the leader 104 begins welding following a weld path s₅ towards the reference line A-A′, such that the weld path s₅ is at an angle φ with the weld path s₄. At the same time, the trailer 106 begins welding following a weld path s_{5′} away from the reference line A-A′, such that the weld path s_{5′} is at an angle φ with the reference line A-A′. The tandem wires 104, 106 proceed along their given paths s₅ and s_{5′}, respectively, until the leader 104 pauses at point p₁₀ on the reference line A-A′ and the trailer pauses at point p₆ located a predetermined distance d₂ from the reference line A-A′. Accordingly the length of the path s₅ is equal to the length of the path s_{5′}.

Following the pause at point p₁₀, the leader 104 begins welding along weld path s6 along the reference line A-A′. At the same time, following the pause at point p₆ the trailer 106 begins welding following a weld path s_{6′} parallel to the reference line A-A′. Therefore, s_{6′} forms an edge of the weld to the left of the reference line A-A′, such that a weld pool is formed between the reference line A-A′ and the weld segment s_{6′}. The tandem wires 104, 106 proceed along their given paths s₆ and s_{6′}, respectively, until the leader 104 pauses at point p₁₁ located on the reference line A-A′, and the trailer 106 pauses at point p₇ located a predetermined distance d₂ from the reference line A-A′. Accordingly, the length of the path s₆ is equal to the length of the path s_{6′}.

Following the pause at point p₁₁, the leader 104 begins welding along weld path s₇, away from the reference line A-A′ and at angle φ with the reference line A-A′. At the same time, following the pause at point p₇ the trailer 106 begins welding following a weld path s_{7′} towards the reference line A-A′, such that the weld path s_{7′} is at an angle φ with the weld path s_{6′}. The tandem wires 104, 106 proceed along their given paths s₇ and s_{7′}, respectively, until the leader 104 pauses at point p₁₂ located a predetermined distance d₁ from the reference line A-A, and the trailer meets the reference line A-A′ at an angle θ and pauses at point p₁₀. Accordingly, the length of the path s₇ is equal to the length of the path sᵣ.

Finally, following the pause at point p₁₂, the leader 104 begins welding along weld path s₈ parallel to the reference line A-A′. At the same time, following the pause at point p₁₀ the trailer 106 begins welding following a weld path sᵣ along the reference line A-A′. Therefore, s₈ forms an edge of the weld to the right of the reference line A-A′, such that a weld pool is formed between the reference A-A′ and the weld segment s_{g}. The tandem wires 104, 106 proceed along their given paths s₈ and s_{8′}, respectively, until the leader 104 pauses at point p₁₃ located a predetermined distance d₁ from the reference line A-A′, the trailer 106 pauses at point p₁₁ located on the reference line A-A′. Accordingly, the length of the path s₈ is equal to the length of the path s_{8′}.

Therefore, in one cycle the leader 104 welds and moves along a path starting from point p₀ to points p₄, p₅, p₈, p₉, p₁₀, p₁₁, p₁₂ and finally to point p₁₃. Simultaneously, the trailer 106 welds and moves along a path starting from point p₁ to points p₂, p₃, p₄, p₆, p₇, p₁₀ and finally to point p₁₁. The weave cycle is the length L of the weld from point p₁ to point p₁₃ along the reference line A-A′. A resultant bead 140 is shown in FIG. 2b, in which the arrows show the direction of travel of the torch 102, and hence the wires 104, 106. In one embodiment, the weave frequency is set at 4 Hz, such that the resultant bead 140 of length L is produced in ¼ seconds. In one embodiment, the bead width (d1+d2) is equal to ¼ inches, such that the displacement d1 or d2 is equal to ¼ inches.

FIG. 2b depicts the results of using the welding tool oscillation pattern of FIG. 2a, wherein vectors a0 to a7 represent the direction and speed of travel of the wires 104, 106, hence the torch 102.

The bead profile is dependent on the weave angle. For instance, the bead profile is flat when a weave angle of 0 degrees is used, while the bead profile is substantially rounded when a weave angle between 0 and 45 degrees. A typical bead has a geometry shown in FIG. 2c, h is the clad height, W is the clad width, σ is the angle of wetting, and b is the clad depth representing the thickness of substrate of part 120 melted during the cladding and added to the clad region. Accordingly, the geometrical dilution may be determined by the formula: b/((h+b)/2), in one exemplary embodiment. Alternatively, dilution may be defined as the percentage of the total volume of the surface layer contributed by melting of the substrate. The oscillation pattern of FIG. 2a is significant as it allows the toe of the puddle to fuse into the part 120, remove any welding impurities for the next welding pass and reduce a defect call undercut which may occur when trying to weld at high speeds.

As can be seen in FIG. 3a, the trailing electrode 106 angle pushes the molten weld pool opposite the direction of travel of the torch 102 thereby resulting in deeper penetration. The multi axis or robotic system should be able to perform 4 to 1 principle, that is, when the welding torch 102 travel speed is 4 mm/s then solidification along the weld reference line A-A′ starts approximately 1.5 seconds after passage of the wire 104 or 106 (or sooner). The combination of the oscillation pattern and the high travel speed in the HSRC system 100 represents a significant improvement over the prior art metal cladding technology, both in terms of time and cost. FIGS. 3b and 3c show illustrative cladding results obtained using system 100.

In another embodiment, the weave angle may be adjusted to result in less dilution, higher wire deposit rate (lb/hr), and to help with the puddle size.

In another embodiment, the oscillation frequency may be varied to control the size and speed of the weaving angle, and to help control the lack of fusion defects. The oscillation frequency may also be used to control how often the torch moves from the center, and to the right and left of the center of the welding puddle.

The defect free results with system 100 is achieved by the removal of virtually all oxidized impurities from the surface with the tandem-welding arc, as the machine is running with the right parameters and setup. More particularly, experimentation and studies have revealed the following:

(1) robotic tandem pulse welding can produce an inch and quarter wide convex bead at 4 mm in height with good weldability and molten pool control;
(2) cycle time can be cut in half in comparison to MIG and strip processes. Using system 100, there was an increase in the consumption of welding wire 104 or 106, from 12 to 15 lbs/hr to 24 to 30 lbs/hr;
(3) the low dilution levels kept solidification shrinkage under control and helped prevent cracking of the bead. The use of welding wire 104, 106 and the above-noted welding parameters helped to improve metallurgical and mechanical properties of the welding pool; and
(4) the significant reduction of dilution cracking and amount of iron pick with system 100, and the decrease of heat input while welding provides better grain structure of the bead. While the weld procedure specification (WPS) instructions call for maximum of 116 kJ for SA 516-Gr 70 part 120 in the MIG welding process, while using system 100 on the same part 120 only produces 19 kJ.

Investigative work has been completed has shown that this layer can be deposited quicker and with a higher quality than that currently being done in industry, leading to significant savings in material costs and manufacturing time. As an illustrative example, using prior art processes, a 24-inch diameter tube sheet (SA 516-G70) 120 may be clad in 26 hours at a cost $5,874.00, at a welding speed of 5 inches per minute in a semi-automatic process with Inconel 52 wire. In comparison, with system 100 the same part 120 would be clad in 1.5 hours and cost less than $1,000.00, at a welding speed of over 37 inches per minute in a fully automatic cladding process, and production output was increased without compromising quality or safety, and the part 120 had minimal dilution in the range of 7% to 12%. Dilution is the amount of iron picked up in the welding puddle from the base metal of part 120. Accordingly, the approximate savings in cost and time are very significant.

To further illustrate the cost savings that may be achieved with the HSRC system 100, in one example, using a prior art methods, the estimated time to clad a 12.5 foot diameter by 8-inch thick tube sheet 120 it would take approximately 792 hours or 33 days in cycle time at a cost of over $70,000 per unit in wire 104, 106 and shielding gas; however, using the system 100 employing the exemplary weaving pattern of FIG. 2a, and at the above-noted welding speeds the same 12.5 feet diameter by 8-inch thick tube sheet 120 is clad in 35 hours, or 1.75 days in cycle time, at a cost of over $58,000 per unit in wire 104, 106 and shielding gas. It is clearly apparent that the use of the system 100 employing the high-speed torch 102 oscillating according to the pattern of FIG. 2a results in a significant reduction in time and cost, while producing consistent beads.

Table C further illustrates the labour and cost advantages of the system 100 in comparison to a prior art MIG process.

TABLE C
Material breakdown for Cladding a 7 foot tube sheet

| | MIG Process (Prior art) | vs HSRC Process |
|---|---|---|
| Shielding gas | 60 CFH ($1.36/CF) | 240 CFH ($1.36/CF) |
| Travel Speed | 5 in/min (1 Pass) | 37 in/min (1 Pass) |
| CF/H | 1,915 | 618 |
| Cost | $2,605.26 | $840.84 |
| Travel Speed | 5 in/min (5 Passes) | 37 in/min (3 Passes) |
| CF/H | 9,578 | 2,473 |
| Cost | $13,026.28 | $3,363.36 |
| Heat Input (kJ) | 116 | 19 |
| Deposition (cubic | 386.7 | 293 |
| inches)/layer | | |
| Wire (lbs) | 1933 | 1172 |
| Wire cost/lb | $28.85 | $28.85 |
| Time (days) | 18 | 2 |
| Cost | $55,774.77 | $33,694.34 |

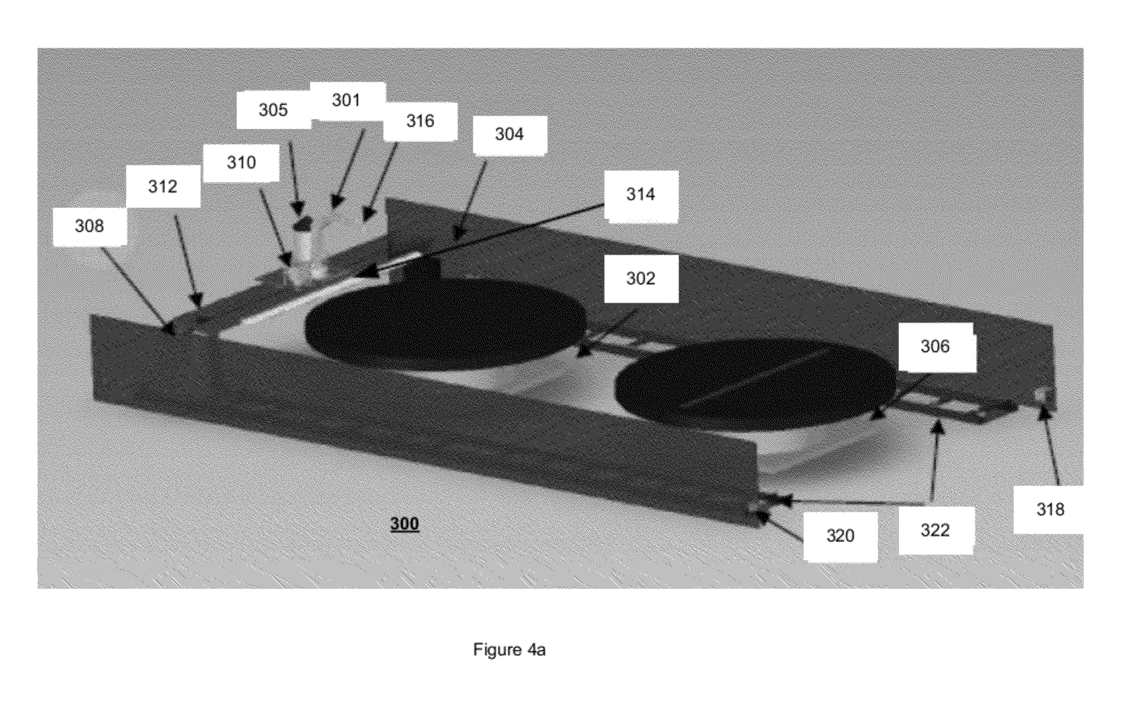

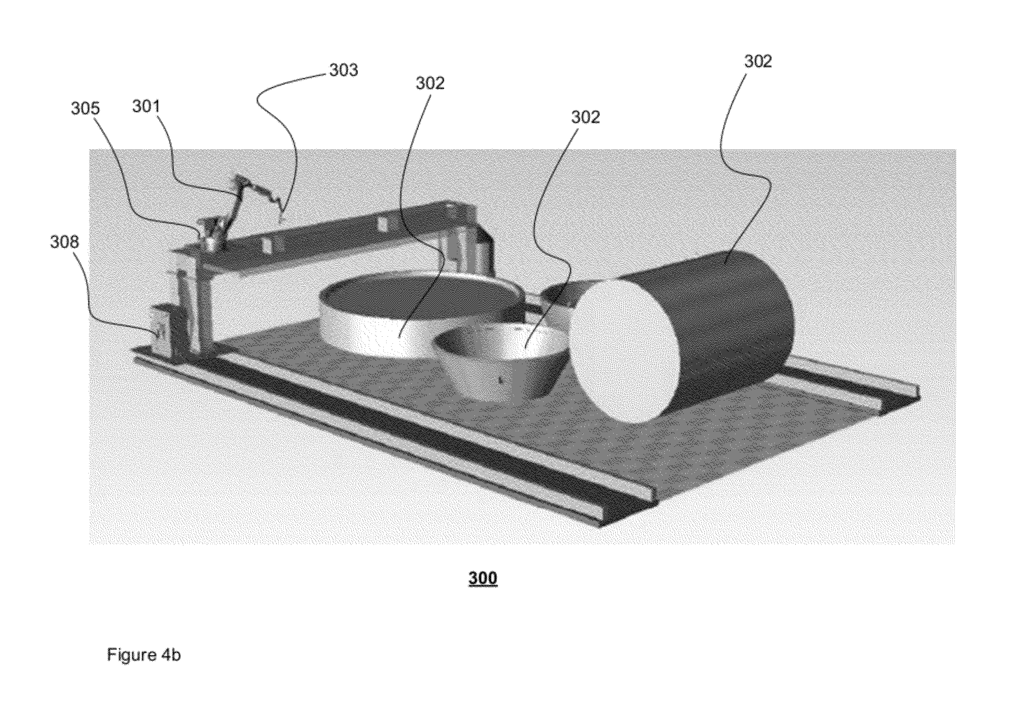

Now referring to FIGS. 4a and 4b, there is shown an exemplary work cell 300 for providing a suitable operating environment for system 100. A multi-axis robot, such as a 6-axis MIG welding robot or 8-axis MIG or TIG welding robot 301 may be used to perform overlay welding of a part 302. A robot controller 304 with an operator interface, such as an Allen Bradley Panel View Plus 1000/PLC 1 Allen Bradley Compact Logix provides commands to a welding torch 303 for the welding process. Large wire drums 305 may be provided to allow the welding robot 301 to weld for prolonged periods without having to stop to replenish the wire supply.

The part 302 is held in a fixed position on a grounded part station 306, thus eliminating common grounding problems associated with rotating parts with positioners in prior art methods. In prior art methods, the lack of proper grounding results in sputtering, and erratic arcs, and results in frequent adjustment the wire feed speed and the voltage during welding, as the arc appears to be unbalanced. In addition, a rotating positioner requires accurate control of the angular (or linear) speed of a rotating disk, which is often difficult to achieve, and therefore results in inconsistent welds. Unlike prior art systems that require a positioner in order to accommodate a wide variety of repair parts, such as shafts, disks, rings, to manipulate or rotate the parts about a horizontal or vertical axis, the system 100 instead causes the torch 303 to rotate about the part 302, such that cylindrical parts (such as shafts) or flat parts, such as disks and rings may be readily processed. The torch 303 with the aid of the robot 301 may be placed in any position with respect to the part 302. In one example, a bead using the weaving pattern of FIG. 2a may be deposited on the interior of a cylinder 302 such that the entire interior surface of that cylinder 302 is clad in sequence by a series of abutting bead rings. Similarly, the exterior of the cylinder 302 may also be clad. The cladding may also be performed upside-down, or at any angle in relation to the part 302 surface. Accordingly, by keeping the part 302 in a fixed, non-rotating state, grounding problems caused by turning the part 302 during cladding, inherent in prior art systems, are eliminated. Advantageously, a part 302 may be continuously clad without excessive stopping and at higher speeds than in prior art systems, thus saving resources, such as time and cost.

A tandem MIG welding package system 308 is coupled to the robot 301 and robot controller 304, the system 308 includes tandem power supplies for producing the welding current, amps and voltage, and also provides water cooling to remove the excessive heat. A torch cleaner system 310 may be provided to clean the welding torch 303. The robot 301 is held in a 3-axis gantry fabrication cell/setup or robotic cell/setup 312, which allows the system 100 to have an extra axis for welding. A ventilation system 314 may be provided to remove welding fumes, ozone, or smoke that may collect in the welding area. Typically, the ventilation system 314 is localized and uses fixed or flexible exhaust pickups which force the exhaust away from the affected welding area, or its vicinity, at a predetermined and acceptable rate.

Multiple cameras 316 may be provided to allow an operator to see the welding process from multiples angles, and allows the operator to manually or automatically make fine adjustments of the parameters from a remote location, thus protecting the operator from harmful radiation or toxic gases, airborne particles containing Cr, Ni, Cu, and other harmful elements potentially released during cladding. The cameras 316 monitor the wire tip position in relation to the weld pool, and provide front and side view images of the weld pool area on a split-screen video monitor. An infrared sensor is used to measure the interpass temperature of the part 302 being clad, to ensure that the highest part 302 quality will be maintained from a metallurgical standpoint.

A light stack 318 may be used as a safety guard, and guarding lot zone scanners and wire mesh guarding 320 may be used for safe operation of the cell 300. Extendable tracks 322 may be provided to allow the robot 301 to be positioned in different locations in the cell 301. In another embodiment, multiple robots may be placed in the cell 300.

In addition to cladding the parts 120, 302 with beads on plate, a plurality of other welds, such as butt and fillet welds are also possible with the above-mentioned method of system 100.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The features described herein can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language including compiled or interpreted languages, and it can be deployed in any form, including as a stand-alone program or as a module, component, subroutine, or other unit suitable for use in a computing environment.

The preceding detailed description is presented for purposes of illustration only and not of limitation, and the scope of the invention is defined by the preceding description, and with respect to the attached claims.

The embodiments of the invention in which an exclusive property or privilege is claimed are defined as follows:

1. A method of cladding a metal using a programmable robotic welding torch having a leader wire and a trailer wire, the method comprising the steps of:
providing a non-transitory machine readable medium comprising instructions stored thereon and executable by a processor to cause the processor to:
oscillate the torch about a reference weld line on a surface of the metal having at a predefined speed to form a weld bead by:
positioning the leader at point p₀ located a predetermined distance from the reference weld line;
positioning the trailer at point p₁ on the reference line;
causing the leader to begin welding from point p₀ along a weld path s₁ towards the reference line, such that the weld path s₁ meets the reference line at an angle θ; and simultaneously causing the trailer to begin welding from point p₁ along weld path s_{1′} away from the reference line, such that the weld path s_{1′} meets the reference line at an angle φ;
causing the leader and the trailer to proceed along the weld paths s₁ and s_{1′}, respectively, until the leader pauses at point p₄ on the reference line and the trailer pauses at point p₂ located a predetermined distance from the reference line;
causing the leader to begin welding from point p₄ along weld path s₂ along the reference line; and simultaneously causing the trailer to begin welding from point p₂ along a weld path s_{2′} parallel to the reference line;
causing the leader and the trailer to proceed along the weld paths s₂ and s_{2′}, respectively, until the leader pauses at point p₅ on the reference line and the trailer pauses at point p₃ located a predetermined distance from the reference line;
causing the leader to begin welding from point p₅ along weld path s₃ away from the reference line at an angle φ with the reference line; and simultaneously causing the trailer to begin welding from point p₃ along a weld path s_{3′} towards the reference line such that the weld path s_{3′} is at an angle φ with the weld path s_{2′};
causing the leader and the trailer to proceed along the weld paths s₃ and s_{3′}, respectively, until the leader pauses at point p₈ located a predetermined distance from the reference line and the trailer meets the reference line at an angle θ and pauses at point p₄;
causing the leader to begin welding from point p₈ along weld path s₄ parallel to the reference line; and simultaneously causing the trailer to begin welding from point p₄ along a weld path s_{4′};
causing the leader and the trailer to proceed along the weld paths s₄ and s_{4′}, respectively, until the leader pauses at point p₉ located a predetermined distance from the reference line and the trailer pauses at point p₅ located on the reference line;
causing the leader to begin welding from point p₉ along weld path s₅ towards the reference line, such that the weld path s₅ is at an angle φ with the weld path s₄; and simultaneously causing the trailer to begin welding along weld path s_{5′} away from the reference line, such that the weld path s_{5′} is at an angle φ with the reference line;
causing the leader and the trailer to proceed along the weld paths 5 and s_{5′}, respectively, until the leader pauses at point p₁₀ on the reference line and the trailer pauses at point p₆ located a predetermined distance from the reference line;
causing the leader to begin welding from point p₁₀ along weld path s₆ along the reference line; and simultaneously causing the trailer to begin welding from point p₆ along weld path s_{6′} parallel to the reference line;
causing the leader and the trailer to proceed along the weld paths s₆ and s_{6′}, respectively, until the leader pauses at point p₁₁ located on the reference line, and the trailer pauses at point p₇ located a predetermined distance from the reference line;
causing the leader to begin welding from point p₁₁ along weld path s₇ away from the reference line and at angle φ with the reference line; and simultaneously causing the trailer to begin welding from point p₇ along weld path s_{7′} towards the reference line, such that the weld path s_{7′} is at an angle φ with the weld path s_{6′};
causing the leader and the trailer to proceed along the weld paths s₇ and s_{7′}, respectively, until the leader pauses at point p₁₂ located a predetermined distance from the reference line, and the trailer meets the reference line at an angle θ and pauses at point p₁₀;
causing the leader to begin welding from point p₁₂ along weld path s₈ parallel to the reference line; and simultaneously causing the trailer to begin welding following a weld path s_{8′} along the reference line; and
causing the leader and the trailer to proceed along the weld paths s₈ and s_{8′}, respectively, until the leader pauses at point p₁₃ located a predetermined distance from the reference line, and the trailer pauses at point p₁₁ located on the reference line.

2. The method of claim 1 wherein the paths parallel to the reference line and located at the predetermined distance form edges of the bead.

3. The method of claim 1 wherein the leader travels from point p₀ to point p₁₃ in ¼ seconds, and the trailer travels from point p₁ to point p₁₁ in ¼ seconds such that point p₀ to point p₁₃ or point p₁ to point p₁₁ represents one cycle.

4. The method of claim 1 wherein the torch travels at a speed between 66 cm/minute to 95 cm/minute while minimizing weld defects and lack of fusion and without excessive stopping.

5. The method of claim 3 wherein oxidized impurities from the surface are removed while the torch is welding.

6. The method of claim 1 wherein when the torch travels at a speed between 4 mm/s then solidification along the weld starts at least 1.5 seconds after passage of the wire.

7. The method of claim 1 wherein heat input while welding a SA 516-G70 metal in a MIG welding process is 19 kJ, and wherein the torch travel speed and the heat input contribute to a low inter-pass temperature resulting in a defect-free grain structure in the metal.

8. The method of claim 7 wherein the bead is a quarter inches.

9. A method of controlling a robot tool to perform a weaving action for producing a weld on a part with a torch having at least two wires, the method comprising the steps of:
programming an oscillation pattern for the robot tool defined by a set of parameters, the oscillation pattern including a pause at each of a center position, a lateral left position and a lateral right position relative to the weld;
programming the torch travel speed of at least 9 inches per second;
programming a corresponding wire feed speed for each of the at least two wires; and
delivering sufficient power to the welding torch such that each of the at least two wires produce a common molten pool dictated by programmed oscillation pattern, and at the programmed torch travel speed.

10. The method of claim 9 wherein the set of parameters comprises one or more of a stickout, oscillation amplitude, weave angle, and oscillation frequency.

11. The method of claim 10 wherein the weave angle is between 0 and 45 degrees.

12. The method of claim 10 wherein the frequency is 4 Hz.

13. The method of claim 12 wherein the stickout is between 17 millimeters and 20 millimeters.

14. The method of claim 13 wherein the bead is produced on the part with the torch traveling relative to the part surface while depositing the molten wire longitudinally, wherein the part is held is a stationary position.

15. The method claim 13 wherein the bead is produced on the part with the torch traveling horizontally and/or vertically relative to the part while depositing the molten wire, wherein the part is held fixedly to a grounded part holding station, thereby eliminating common grounding problems.

16. The method of claim 9 wherein each of the at least two wires is supplied to the torch independently by a first wire feeder for pulling one of the at least two wires from a wire drum and a second wire feeder adjacent to the torch for pulling one of the at least two wires from the first wire feeder, such that the drag of one the at least two wires is controllable for a consistent predetermined wire feed rate while minimizing elongation of one of the at least two wires.

17. The method of claim 9 wherein the heat input while welding the part is maintained below 19 kJ, and wherein the torch travel speed and the heat input contribute to a low inter-pass temperature resulting in a defect-free grain structure in the metal of the part and minimal slag.

18. The method of claim 13 wherein dilution is between 7% and 12% thereby minimizing solidification shrinkage and cracking.

19. The method of claim 18 wherein the dilution is determined in part by the weave angle.

20. A metal cladding process using an automated welding tool, the tool comprising at least one torch for receiving two weld wires to produce a molten pool on the metal, the process having the steps of:
providing a set of instructions in a non-transitory computer readable medium, the instructions executable by a processor to:
control the travel speed of the at least one torch;
control the feed speed of the two weld wires to the torch;
control the stickout of the two weld wires;
control the angle of the weld wires relative to the metal;
control an oscillation pattern and frequency of the at least one torch, the oscillation pattern comprising a pause at each of a center position, a lateral left position and a lateral right position relative to a weld reference line;
control the power to the at least one torch; and
whereby the oscillation pattern produces a weld bead having low dilution with minimal solidification shrinkage and cracking.
